(19) United States
(12) Patent Application Publication
(10) Pub. No.: US 2015/0258356 A1
(43) Pub. Date: Sep. 17, 2015

(54) FOAM PROPORTIONER SYSTEM

(71) Applicant: Michael Sulmone, Hatboro, PA (US)

(72) Inventor: Michael Sulmone, Hatboro, PA (US)

(21) Appl. No.: 14/636,704

(22) Filed: Mar. 3, 2015

Related U.S. Application Data
(60) Provisional application No. 61/947,693, filed on Mar. 4, 2014.

(51) Int. Cl. A62C 5/00

(52) U.S. Cl. CPC A62C 5/002

(57) ABSTRACT

An integrated around the pump (ATP) foam proportioning system that combines the venturi eductor, metering valve and shut-off valve into a single unit. Furthermore, the metering valve stem is contoured to make the flow read-out substantially linear. The display is also designed with movable components to display a single flow at the selected foam percentage rate.

### CROSS-REFERENCE TO RELATED APPLICATIONS

The invention claims priority to U.S. Provisional Patent Application Ser. No. 61/947,693, filed on Mar. 4, 2014, the complete contents of which are herein incorporated by reference.

### BACKGROUND OF THE INVENTION

1. Field of the Invention

The invention relates to the field of firefighting systems, and more particularly to proportioning systems for delivering firefighting foam into a water stream.

2. Brief Description of the Related Art

Venturi based eductor systems are commonly used to draw a firefighting foam concentrate into a water stream to enhance the water's ability to extinguish a fire. A portion of the discharge water from the pump is diverted through the venturi to accelerate the velocity and thus reducing the pressure of the water. Within the region of the water that is below atmospheric pressure, there is a port that introduces the foam concentrate into the water stream. The stream of water and foam agent is returned back to the inlet of the pump. The foam proportioning rate is controlled by a metering valve that limits the flow of concentrate into the venturi. There are usually a complex set of graduations indicating the flow rates and sometimes percentage of concentrate mixed. This system is commonly known as an “Around the pump” (ATP) proportioning system.

Typical ATP systems are composed of separate components; venturi eductor, metering valve, plumbing components. To stop the flow of foam into the water stream, the metering valve is generally closed off completely. This method works but is inconvenient when the system operator wishes to maintain the same setting and not disturb the metering valve position between activities. To overcome this limitation, a second “shut-off” valve is commonly introduced. This also works well, but adds an additional component and associated plumbing into the system which adds complexity and cost.

### SUMMARY OF THE INVENTION

The invention is an integrated ATP foam proportioning system and apparatus that combines the venturi eductor, metering valve and shut-off valve into a single unit. Furthermore, the metering valve stem is contoured to make the flow read-out substantially linear. The display is also designed with movable components to display a single flow at the selected foam percentage rate.

In addition, some embodiments include a feature, where the inflow inlet, e.g., for supply water, and the outflow outlet, e.g., for the water containing the foam concentrate, are reversible on the unit, to facilitate positioning or connecting lines to the unit, such as, for example, water inlet supply lines and/or outlet lines.

The system and apparatus may be used to regulate a flow of foam concentrate through the apparatus, and also may be used to regulate a flow of a water input through the unit. A control is provided, preferably in the form of a valve, that may be used to introduce or block foam. The apparatus and system preferably also may include indications of foam percentage. According to a preferred embodiment, a knob with a window that is configured with one or more other components that regulate the flow, is provided to indicate a flow rate. The knob may serve as an adjustment component to position a metering valve to adjust the flow through the apparatus.

### BRIEF DESCRIPTION OF THE DRAWING FIGURES

FIG. 1 is a drawing that shows a cross-sectional view of the foam proportioner assembly described in this application, the section being taken through the foam inlet and metering valves, along the section line 1-1 of FIG. 2.

FIG. 2 shows a front view of the assembly of FIG. 1.

FIG. 3 shows a side view of the assembly of FIG. 1.

FIG. 4 shows a cross-sectional view of the foam proportioner assembly described in this application that goes through the venturi eductor section, the section being taken through the section line 4-4 of FIG. 3.

FIG. 5 shows a rear perspective view of the assembly of FIG. 1.

FIG. 6 shows a front perspective view of the assembly.

### DETAILED DESCRIPTION OF THE INVENTION

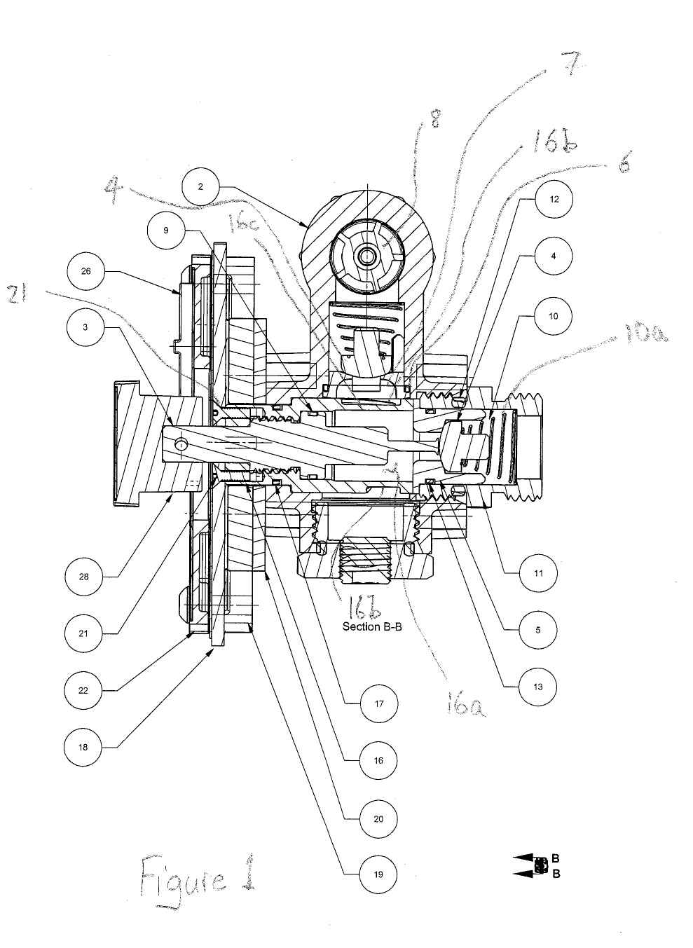

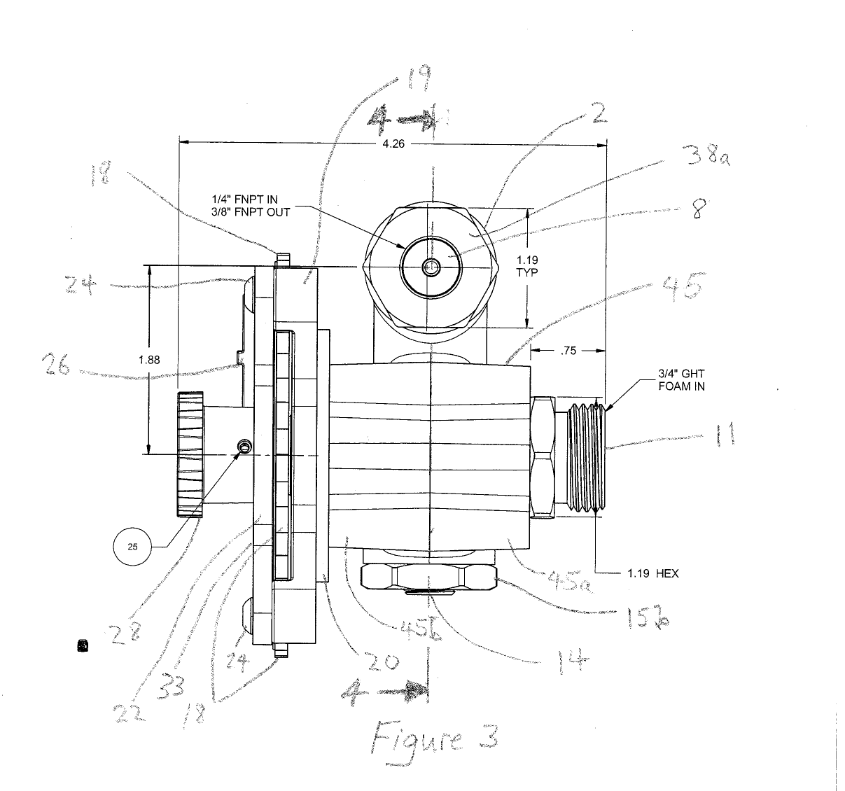

Referring to FIGS. 1-6, a preferred embodiment of an around the pump proportioner (ATP) assembly 100 according to the invention is illustrated. According to a preferred embodiment, as illustrated in the accompanying figures, the ATP proportioner assembly 100 is shown having a body 2 and three fluid connection points, which include a foam inlet 11, a water inlet 15 and an outlet 38. The water inlet 15 shows a connection of a fitting 15a (e.g., such as a water supply fitting) to the assembly body 2, with an o-ring washer 12 sealing the connection. The outlet 38 shows a connection of an outlet fitting 38a (e.g., such as an outlet conduit fitting) connected to the assembly body 2, also with an o-ring washer 12. The water enters the water inlet 15 and accelerates through the nozzle 1 to a low pressure. The water flow joins with the foam concentrate flow in the mixing chamber 40 and continues to the diffuser 8. In the diffuser 8 the solution recovers pressure and then flows through the outlet 38 and then travels to the fire-fighting pump inlet. In a preferred embodiment illustrated, the venturi eductor components, such as, for example, the nozzle 1 and diffuser 8, and body 2, in which they are housed, are provided in an assembly 100 which includes a foam inlet 11 regulatable by a valve stem 3 and valve seal 4, and which further includes a metering valve stem 16 that regulates the admission of the flow of foam from the foam inlet 11 (which has passed the valve seal 4) to a mixing chamber 40.

The foam concentrate enters through the foam inlet 11. When the valve seal 4 (in FIG. 1) is closed against the seat 5 the flow of foam through the port 11 blocked. The valve seal 4 is biased to the closed position by a spring 10a (FIG. 1). Foam flow is regulated by a foam flow component comprising a knob 28. The foam flow knob 28 is shown connected to the flow valve stem 3. According to a preferred embodiment, a set screw 25 secures the knob 28 on the valve stem 3. To initiate foam flow, the foam flow knob 28 is turned CW from “OFF” to “ON”. This movement causes the valve stem 3 to unseat the valve seal 4 (FIG. 1) from the seat 5 due to the threaded section on the valve stem 3. The foam concentrate may then enter the central cavity 16a of the metering valve stem 16. According to a preferred embodiment, an o-ring 13 is shown disposed on the valve seat 5.

The foam flow valve (shown comprising the foam flow stem 3, seal 4, seat 5, and spring 10a) and metering valve components (shown comprising the metering valve stem 16 and metering valve seat 7) are co-linear in the illustrations. According to a preferred embodiment illustrated, the foam flow valve stem 3 and metering valve stem 16 are co-linear (see FIG. 1). The flow valve stem 3 is shown positioned within the metering valve stem 16 and an o-ring 9 is disposed on the flow valve stem 3 (FIG. 1). A seal 4 and spring 10 are shown provided in conjunction with the metering valve seat 7, and preferably above the slotted opening 7a. As shown in FIG. 1, an o-ring 17 is provided on the metering valve 16, forming a seal between the body 2 and metering valve 16.

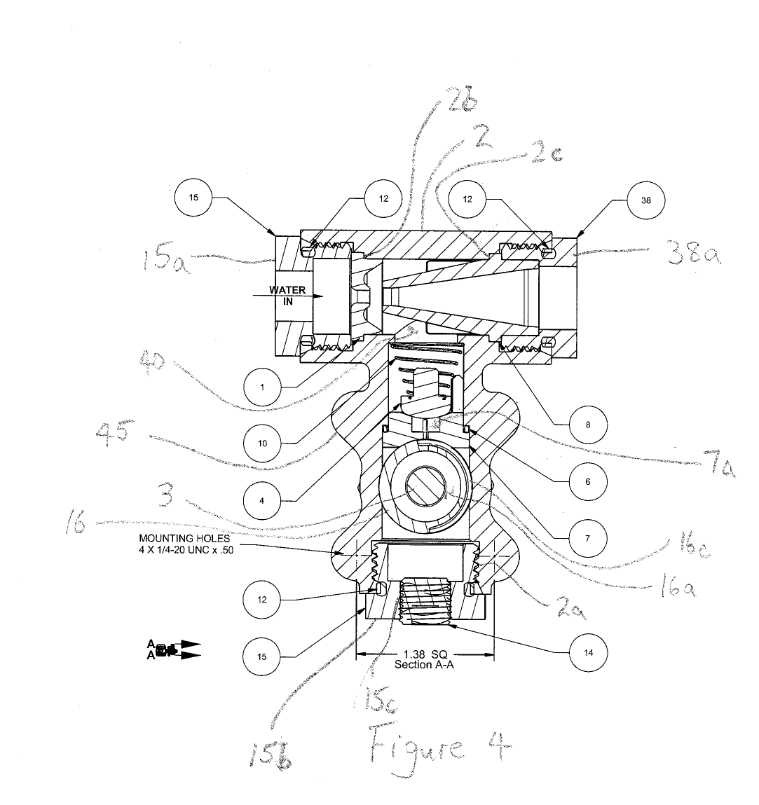

The metering valve stem 16 is connected to the adjustment wheel 18. According to a preferred embodiment, screws 21 connect the wheel 18 to the valve stem 16. To control the aperture opening 16b of the metering valve 16, the adjustment wheel 18 is turned to increase or decrease the opening size (by aligning the position of the opening 16b). According to some preferred embodiments, the opening 16b may be wider at one radial location and narrower at another, as illustrated in FIG. 1. The outside diameter 16c (FIGS. 1 and 4) of the metering valve stem 16 is contoured to block more or less of the slotted opening 7a in metering valve seat 7 depending on its rotational alignment. The contouring of the metering valve stem 16 is designed to allow the flow range of the proportioner 100 to follow substantially uniform angular increments to linearize the flow on the display label 33. An o-ring 6 is shown disposed on the valve seat 7.

Once through the metering valve seat 7, the foam concentrate passes by a check valve seal 4 (FIG. 4) and continues into the mixing chamber 40 (FIG. 4) located between the nozzle 1 and diffuser 8.

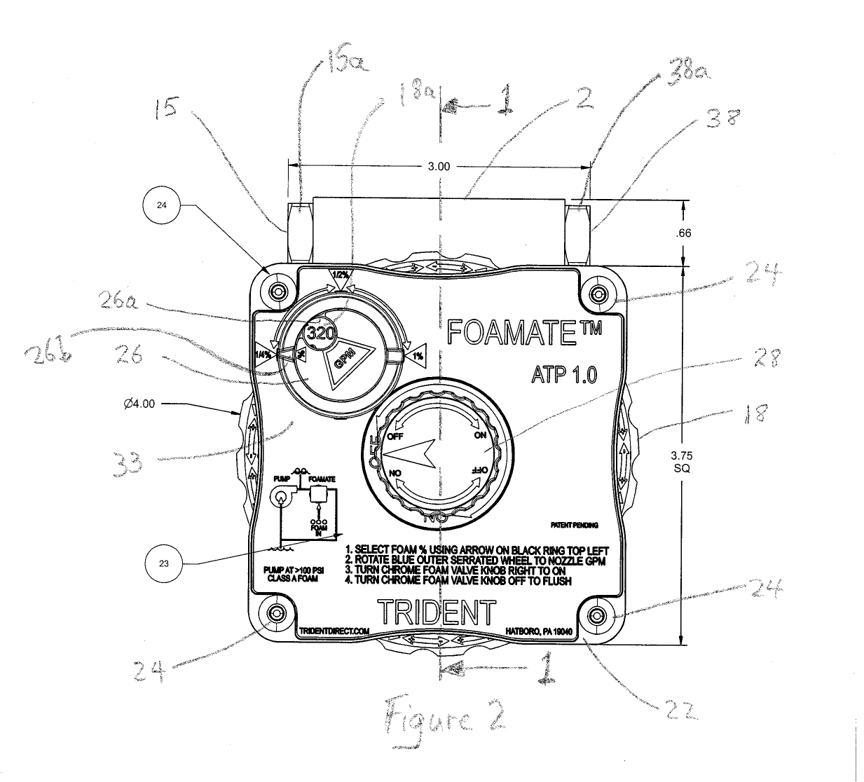

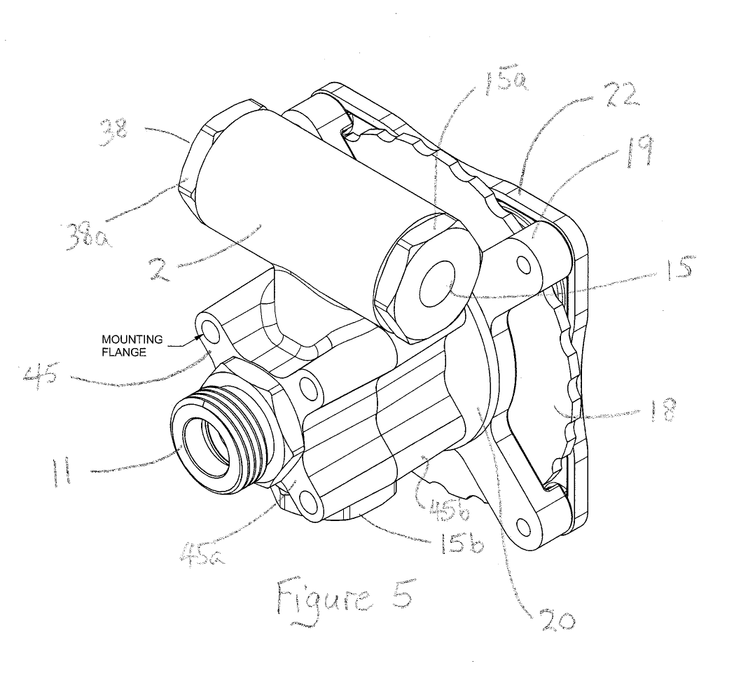

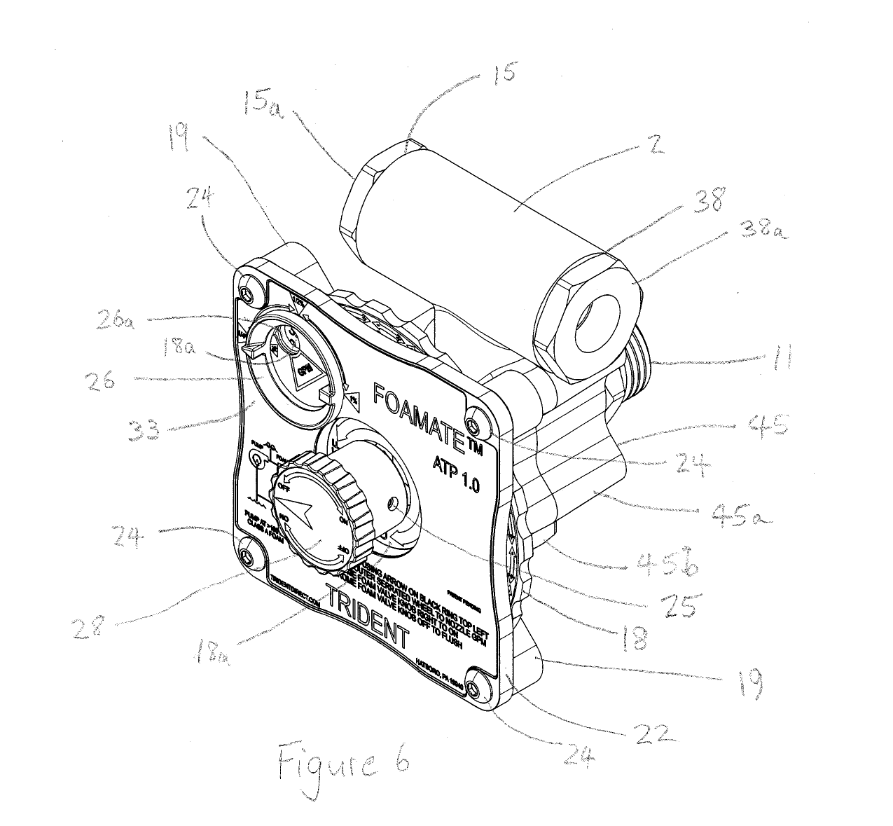

The display label 33 has numbers on it that correspond to total system flow aligned in such a fashion that there are several scales corresponding to various percentage rates of foam concentration. According to one preferred embodiment, the flow rate knob 26 (FIGS. 1 and 6) is rotated in 90° increments to expose various flow rates through the portal 26a in the flow rate knob 26. According to some preferred embodiments, the flow rates may be provided on the face 18a of the adjustment wheel 18, and are visible through the portal 26a. As illustrated in FIG. 2, for example, the flow rate may be provided in gallons per minute (GPM) (or other suitable measurements, or several scales), and, according to a preferred embodiment, flow adjustments may be made by aligning the knob indicator 26b with one of the flow positions, such as, for example, in the embodiment here shown in FIG. 2 as arrows indicating ¼%, ½% 1%, respectively. A support 19 is provided, and preferably connects the face plate or cover 22 to the body 2. The support 19 is shown having arms 19a, with threaded bores therein for receiving screws 24 that secure the cover 22 thereto. A spacer 20 is shown provided between the body 2 and the support 19 (see FIGS. 1 and 5).

The nozzle 1 is captured between the body 2 and the inlet fitting 15a. The diffuser 8 is captured between the body 2 and the outlet fitting 38a. Preferred embodiments provide a configuration, as illustrated, where the nozzle 1 and diffuser 8 may be removed and reversed to allow for ease of plumbing with different arrangements with no change in operation. According to a preferred embodiment, as illustrated in FIG. 4, the body 2 may include annular grooves 2c,2d at each opening thereof configured to engage a flange or ridge of a respective component, such as, for example, the ridge 1a of the nozzle 1 and ridge 8a of the diffuser 8. The diffuser 8 and nozzle 1 may be interchanged, if desired, with the nozzle ridge 1a and diffuser ridge 8a mating with either one of the body ridges 2b,2c.

A fitting 15b, which, according to some preferred embodiments, may be similar or identical to the fitting 15a (and fitting 38a) is shown connected to a lower opening 2a in the body. A plug 14 is shown threaded and received in the threaded bore 15c of the fitting 15b. The bore 15c and/or fitting 15b may be provided for cleanout of the assembly 100 (e.g., when the plug 14 or fitting 15b is removed) or for facilitating introduction of another line or component (e.g., a cleaning flow of water or other fluid).

Referring to FIG. 5, a mounting flange 45 preferably is provided to facilitate mounting of the assembly 100 onto a frame, pump or other support. The mounting flange 45 may be provided in a plurality of components, as shown according to a preferred embodiment, comprising a first component 45a and second component 45b.

These and other advantages may be realized with the present invention. While the invention has been described with reference to specific embodiments, the description is illustrative and is not to be construed as limiting the scope of the invention. Various modifications and changes may occur to those skilled in the art without departing from the spirit and scope of the invention described herein and as defined by the appended claims.

What is claimed is:

1. An around the pump proportioner assembly, comprising:
a body;
a foam inlet;
a water inlet;
an outlet; and
a flow adjustment component.

2. The assembly of claim 1, including a nozzle and a diffuser.

3. The assembly of claim 2, wherein the nozzle is disposed in said body at the water inlet and wherein the diffuser is disposed in said body at the outlet.

4. The assembly of claim 3, wherein said body has a first opening and a second opening, and wherein said nozzle and said diffuser are configured to be interchangeably disposed in one of said first opening and said second opening.

5. The assembly of claim 4, wherein said inlet comprises the opening of said first and second openings in which said nozzle is disposed and wherein said outlet comprises the opening of said first and second openings in which said diffuser is disposed.

6. The assembly of claim 1, wherein said body includes a mixing chamber.

7. The assembly of claim 6, said flow adjustment component comprising a component for regulating the flow rate of fluid into the mixing chamber of fluid supplied through said foam inlet.

8. The assembly of claim 6, including a metering valve disposed between said foam inlet and said mixing chamber.

9. The assembly of claim 8, further including a check valve disposed between said metering valve and said mixing chamber.

10. The assembly of claim 1, including a regulatable valve for blocking and opening the flow path from said foam inlet.

11. The assembly of claim 10, wherein said regulatable valve comprises a valve stem, a valve seat and a spring.

12. The assembly of claim 8, wherein said metering valve includes an actuator, and wherein said actuator is operable to rotate said metering valve to adjust the flow rate of fluid from said foam inlet.

13. The assembly of claim 12, including a regulatable valve for blocking and opening the flow path from said foam inlet.

14. The assembly of claim 12, wherein said actuator comprises a rotatably mounted adjustment wheel.

15. The assembly of claim 14, wherein said adjustment wheel is connected to said metering valve.

16. The assembly of claim 1, wherein said metering valve comprises a metering valve stem and a metering valve seat.

17. The assembly of claim 16, wherein said metering valve stem is contoured to increase or decrease flow based on the position of the contour relative to the metering valve seat.

18. The assembly of claim 16, wherein said metering valve seat has a slot therein, and wherein said metering valve stem includes an opening therein that is movable in relation to said slot to increase or decrease the opening through the valve stem.

19. The assembly of claim 18, wherein said metering valve includes an actuator, and wherein said actuator is operable to rotate said metering valve stem to adjust the flow rate of fluid from said foam inlet.

20. The assembly of claim 18, including a check valve disposed between said metering valve seat and said slot.

21. The assembly of claim 16, wherein said metering valve stem is contoured, and wherein said flow read-out is substantially linear.

22. The assembly of claim 21, including a display, wherein said display comprises movable components that display a single flow rate at the selected foam percentage rate.

23. The assembly of claim 22, including a knob and knob indicator portal, said knob being rotatable between a plurality of positions, each position corresponding with a flow rate.

24. An around the pump proportioner assembly, comprising:
a body having at least three connecting points;
a foam inlet comprising a first one of said at least three connecting points;
a water inlet comprising a second one of said at least three connecting points;
an outlet comprising a third one of said at least three connecting points;
a nozzle;
a diffuser;
wherein the nozzle is disposed in said body at the water inlet and wherein the diffuser is disposed in said body at the outlet;
wherein said body has a first opening and a second opening, and wherein said nozzle and said diffuser are configured to be interchangeably disposed in one of said first opening and said second opening;
wherein said inlet comprises the opening of said first and second openings in which said nozzle is disposed and wherein said outlet comprises the opening of said first and second openings in which said diffuser is disposed;
wherein said body includes a mixing chamber;
a metering valve disposed between said foam inlet and said mixing chamber;
a check valve disposed between said metering valve and said mixing chamber;
a regulatable valve movably provided to selectively block and open the flow path from said foam inlet;
wherein said regulatable valve comprises a valve stem, a valve seat and a spring;
wherein said metering valve includes an actuator, and wherein said actuator is operable to rotate said metering valve to adjust the flow rate of fluid from said foam inlet into said mixing chamber;
wherein said actuator comprises a rotatably mounted adjustment wheel;
wherein said adjustment wheel is connected to said metering valve;
wherein said metering valve comprises a metering valve stem and a metering valve seat;
wherein said metering valve seat has a slot therein, and wherein said metering valve stem includes an opening therein that is movable in relation to said slot to increase or decrease the opening through the valve stem; and
a check valve disposed between said metering valve seat and said slot.
